(19) United States
(12) Patent Application Publication
(10) Pub. No.: US 2006/0177361 A1
(43) Pub. Date: Aug. 10, 2006

(54) Crystallized film and process for production thereof

(75) Inventor: Hideya Kumomi, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/559,998

(22) PCT Filed: Jun. 9, 2004
(86) PCT No.: PCT/JP04/08405

§ 371 Date: Dec. 9, 2005

(51) Int. Cl. B01D 9/00

(52) U.S. Cl. 422/245.1

(57) ABSTRACT

A process for producing a crystallized film is provided which comprises a step of preparing a film having a crystal grain at a prescribed location, a step of melting a part of a region surrounding the crystal grain of the film and a part of a boundary between the crystal grain and the surrounding film locally by pulse heating, and a step of re-solidifying the melted region.

### TECHNICAL FIELD

The present invention relates to a crystallized film applicable to large-scale integrated circuits requiring high spatial uniformity for flat panel displays, image sensors, magnetic recording apparatuses, information processing apparatuses; a process for production of the crystallized film; an element employing the crystallized film; a circuit employing the element; and a device containing the element or the circuit.

### BACKGROUND ART

Flat panel display represented by liquid crystal displays and the like have been improved for higher definition, higher speed, and a higher degree of gradation by monolithic implementation of a pixel-driving circuit on a panel and by improvement of the performance. Simple matrix-driven panels have been replaced with active matrix-driven panels which have pixels having respectively a switching transistor. Further, full-color high-fineness liquid crystal displays are supplied by implementing a shift register circuit for driving the active matrix on the periphery of the same panel.

The monolithic implementation including the peripheral driving circuit at a practical production cost can be made possible owing mainly to the technique of formation of polycrystalline silicon film having excellent electrical properties on an inexpensive glass substrate. By this technique, a thin amorphous silicon film deposited on a glass substrate is melted and re-solidified with the glass substrate kept at a low temperature by short-time pulse light irradiation with an excimer laser or the like in a UV range. The melting-solidification enables formation of a crystal grain of a low crystalline defect density in comparison with a crystal grain constituting the polycrystalline film crystallized in a solid phase from an amorphous silicon film. The film transistor constructed by use of the above film as the active regions has higher carrier mobility. Therefore, even a polycrystalline silicon film having an average crystal grain size of submicrons is useful for producing an active matrix-driving monolithic circuit which has a sufficient performance for liquid crystal display of definition of 100 ppi or less.

However, it is obvious that the film transistor employing the existing re-solidified polycrystalline silicon film transistor does not have sufficient performance yet for a larger screen or a higher definition of a liquid crystal display for next generation. The above polycrystalline silicon film is insufficient in the performance also for future promising applications requiring a higher voltage and larger electric current for driving such as driving circuit element of plasma display and electroluminescence display, and high-speed driving circuit element for a medical large screen X-ray image sensor. A high performance element cannot be obtained from the polycrystalline film of an average grain size of submicrons even if the defect density in the crystal grain is made low. It is because an element having a size of microns has, in its active region, many crystal grain boundaries which become barriers against carrier transport.

For decreasing both of the density of the crystal grain boundaries and spatial distribution thereof in the polycrystalline film, a process of sequential lateral solidification (hereinafter referred to as “SLS process”) is disclosed by Im et al. (R. S. Sposili and J. S. Im, Appl. Phys. Lett., vol. 69, 2864 (1996); Japanese Patent No. 03204986). The SLS process is considered to be a modification of the former zone melting recrystallization technique: the melt region scanning in sequential lateral growth of crystal grains by scanning melting-solidification in the zone melting crystallization process is replaced by sequential transfer and repetition of melt-solidification region by short-time pulse of heating and cooling in the SLS process. In an example shown in the above report, excimer laser crystallization of amorphous silicon film was conducted by sequential irradiation of a laser beam of 5 μm in width by sequential transfer in width direction by 0.75 μm for one shot. In the first shot, the laser-irradiated 5 μm-region comes to be a random polycrystalline state. In the second shot, the completely melted region of 5 μm wide comes into contact at the border with the polycrystalline grains formed by melting-solidification at the first shot, whereby lateral growth occurs from the polycrystalline crystal grains as seeds at the solid-liquid interface. At and after the third shot, the lateral-direction growth continues employing the laterally grown crystal grain as the seeds. Consequently, the crystal grain boundary extends in the laser beam scanning direction and the crystal grains grow in a band shape. As explained above, the SLS process gave possibility of one-dimensional control of the crystal grain boundaries. However, this process conducts merely a one-dimensional control, so that the interval between the crystal grain boundaries, namely the breadth of the crystal grains unavoidably distributes in a broad range. Because the respective band-shaped crystal grains originate from the crystal grains random in the position and grain size, and this randomness continues to the end of the lateral growth. This original randomness further causes snaking, collision, or branching of the crystal grain boundary to impair the one-dimensional control.

For canceling the uncertainty of the SLS process, Japanese Patent No. 03204986 discloses a process of selective growth of a single seed crystal by a patterned amorphous silicon film (H. J. Song and J. S. Im, App. Phys. Lett., vol. 68, 3165 (1996)) combined with the SLS process. In this combined process, an amorphous silicon film is patterned into small regions including a light-shielded portion, narrow bridge regions adjacent to the small region, and isolated islands constituted of a main region adjacent to the other end of the bridge region, and a laser beam is projected thereon in this order by SLS. At the first shot, in the light-shielded portion of the small region, the amorphous silicon is melted incompletely to form fine polycrystalline grains, whereas the amorphous silicon in the surrounding region is melted completely, forming many crystal grains by utilizing the above polycrystal grains as the seed crystals. At the subsequent shots, the crystal grains grow further in the lateral direction, but the growth is restricted by the island pattern of the amorphous silicon film. Thereby the lateral growth is stopped by the bridge region. Since the bridge region is narrow, the crystal grains which grow across the bridge region are selected (filtered). At the subsequent shots, the crystallization proceeds in the main region by utilizing the filtered crystal grains as the seeds by the SLS process. In this process, if a single crystal grain could grow in the light-shielded portion in the small region, or if a single crystal grain could be filtered, the main region would be a single crystal grain constituted of a continuous crystal grain. Actually, however, in the former process employing a temperature distribution in the plane of the film, it is not easy to keep only the single crystal grains unmelted. On the other hand, in the latter process, for filtering the crystal grains, the bridge should be made as narrow as possible for increasing the yield of the single crystal grain, which encounters difficulty in fine patterning technique.

The present invention intends to provide a novel method for controlling two-dimensionally the location of the crystal grains and of the crystal grain boundary in the production process of a crystallized film by the SLS process; a crystalline film with high two-dimensional control of the crystal grains by the above production method; and an element, circuit, and device of high-performance by employing the film.

### DISCLOSURE OF THE INVENTION

According to an aspect of the present invnetion, there is provided a process for producing a crystallized film, comprising the steps of: preparing a film having a crystal grain at a prescribed location; melting a part of a region surrounding the crystal grain of the film and a part of a boundary between the crystal grain and the surrounding film locally by pulse heating; and re-solidifying the melted region.

The film is preferably in contact with a surface of a substrate, and the crystal structure of the surface of the substrate in contact with the region of melting and re-solidification of the film and the crystal structure of the formed crystallized film are not continuous.

The step of re-solidification preferably allows a crystal to grow from the crystal grain at the prescribed location in a lateral direction.

The surrounding region outside the location-controlled crystal grain is preferably completely melted.

The process preferably comprises, after the step of the re-solidification, further a step of melting locally by pulse-heating a portion of the region surrounding the crystal grain having grown in the re-solidification step together with a portion of the boundary between the crystal grain having grown in the step and surrounding film; and a step of re-solidifying the melted region. The repeated step of the melting and re-solidification is conducted plural times. The region of the melting and re-solidification in the repeated step of the melting and re-solidification is preferably overlapped partly with the region of the melting and re-solidification of the preceding step of the melting and re-solidification. The melting-solidification region in the repeated melting-solidification step preferably includes the grain boundary of crystal grain having a crystal structure continuous to the location-controlled crystal grain. Alternatively, the melting-solidification region in the repeated melting-solidification steps covers a region having not been employed yet as the melting-solidification region.

The step of providing a film having a crystal grain placed at a prescribed location may comprise a step of providing a single crystal grain in a specified region of a precursor of the film. The precursor of the film is preferably an amorphous film, and the step of providing a single crystal grain at a prescribed location is preferably a step of growing a crystal grain by solid-phase crystallization of the amorphous film. The step of providing a single crystal grain at a prescribed location is preferably a step of growing a crystal grain by melting-resolidification of the precursor of the film. The step of growing the crystal grain by melting-resolidification of the precursor of the film and the melting and resolidifying steps in the above crystallized film-producing process of the present invention are preferably conducted continuously by means of one and the same heating means. A spatial location of the crystal grain having a continuous crystal structure in the crystallized film is preferably decided by fixing a spatial location of the specified region.

According to another aspect of the present invention, there is provided a crystallized film, comprising a crystal grain placed at a prescribed location, and another crystal grain grown laterally from the grain at a prescribed location.

According to a further aspect of the present invention, there is provided an element, comprising the above crystallized film, and arranging an elementary element in correspondence with the location of the crystal grain. The crystal grains are preferably utilized respectively as an active region of an active element. The active region of the element is preferably formed inside the single crystal grain of the crystallized film.

According to a further aspect of the present invention, there is provided a circuit, comprising the above element, and wiring connected to the element.

According to a further aspect of the present invention, there is provided a device, comprising the above circuit and a semiconductor device or a display device connected to the circuit.

A first embodiment of the present invention is a process for producing a crystallized film, comprising a step of preparing a film having a crystal grain at a prescribed location; a step of melting a part of a region surrounding the crystal grain of the film and a part of a boundary between the crystal grain and the surrounding film locally by pulse heating; and a step of re-solidifying the melted region. The term “prescribed location” herein means predetermined location relative to a reference coordinate defined on the entire film or a local portion of the film, or a relative position defined between the crystal grains. The prescribed location is an intended position of the transistor element to be formed on the crystallized film, and is decided by layout design of the semiconductor circuit. The film for starting the process of production of the present invention is a film having single crystal grains on the above locations.

The location of the crystal grains in the present invention is controlled by the mask layout according to semiconductor device design, the position of a working beam in the production process, the position of the mask, and so forth. Hereinafter, the decision of the position as above is occasionally called “location control”, and the prescribed position is occasionally called “controlled location”.

The present invention is applied mainly to semiconductor films like silicon, but is not limited in the material or the film thickness.

In a preferred embodiment of the process for producing the crystallized film of the present invention through the aforementioned steps, the film is in contact with a surface of a substrate, and the crystal structure of the surface of the substrate in contact with the region of melting-solidification of the film and the crystal structure of the formed crystallized film are not continuous. A specific example is deposition of a film on an amorphous glass substrate. More preferably, like this example, no part of the melting-solidification region is in contact with the surface of a single crystal substrate having the same crystal as the crystal grain constituting the crystallized film.

In the above process of the production, a portion of the crystal grain may be melted in the melting step.

In a preferred embodiment, the surrounding region outside the location-controlled crystal grain is completely melted.

In a preferred embodiment, the crystal grows from the crystal grain at the prescribed location in a lateral direction.

A preferred embodiment of the process for producing the crystallized film of the present invention may comprise, after the step of the re-solidification, further a step of melting locally by pulse heating a portion of the region surrounding the crystal grain having grown in the melting-solidification step with a portion of the boundary between the crystal grains having grown in the step and surrounding film, and a step of re-solidifying the region. That is, the melting-solidification region is transferred in the direction of growth of the crystal grain and the melting-solidification is conducted again to allow the crystal grain to glow further in the lateral direction.

The above steps may be repeated plural times.

The melting-solidification region in the melting-solidification steps conducted repeatedly may be overlapped partly with the melting-solidification region of the preceding melting-solidification. That is, the distance of the transfer of the melting-solidification region is made smaller than the breadth of the melt-solidification region in the transfer direction, and the transfer of the melt-solidification region and the melting-solidification are repeated. In this embodiment, the melting-solidification region in the melting-solidification step preferably includes the boundary between the location-controlled crystal grains and an adjacent crystal grain having a crystal structure continuous thereto.

The melting-solidification region in the aforementioned repeated melting-solidification steps may cover a region having not been employed yet as the melting-solidification region. Thereby, the region after the melting-solidification steps is enlarged to allow the successive growth of the crystal grain in the lateral direction.

In the present invention, the step of providing a film having a crystal grain placed at a prescribed location may comprise a step of providing a single crystal grain in a specified region of a precursor of the film. Here, the “precursor” of the film means a film before the single crystal grain is provided thereon, and is occasionally referred to as a “precursory film” or a “precursory film”. On the precursory film, a specified region is provided at a prescribed location. A single crystal grain is provided in the specified region according to the method described below to prepare a film having a crystal grain placed at the prescribed location. The single crystal grain formed in the specified region may fill a part of the specified region, may fit just into the specified region, or may spread out of the specified region. The location has only to be defined by the specified region.

The methods for providing a specified region of the precursory film and providing a single crystal grain are roughly classified into two as below.

In a first method of providing the single crystal grain, an amorphous film is employed as the precursory film, a specified region is provided thereon, and a crystal grain is grown preferentially in the specified region by solid-phase crystallization of the amorphous film. For providing the specified region for growth of the crystal grain therein by solid-phase crystallization of the amorphous film, various methods may be employed. For example, a specified region is provided to be different from the surrounding region in the size or density or the crystal grain or crystalline cluster, structural relaxation state of the amorphous material, impurity concentration, surface-adsorbed substance, surface state of the film, or the like, and the film is isothermally annealed at a temperature not higher than the melting point of the film. Thereby, a nucleus of a crystal grain or a crystalline cluster contained or preferentially formed in the specified region can be grown.

In a second method of providing the single crystal grain, the single crystal grain is grown in a specified region by melting and solidification of a precursory film. In melting-solidification of the film, the specified region for growth of the single crystal grain can be provided by melting-solidification by the procedure for selective solid-phase crystallization in the amorphous film described in the above first method, or by melting-solidification with the film thickness for the specified region made larger than the thickness corresponding to the surrounding region.

In the case where the above second method is employed, both the step for preparing the film having the location-controlled crystal grain and the step for growing laterally the crystal grain are conducted by melting and solidification. Therefore the former preparation step and the latter main step can be continuously conducted by using the same heating means commonly. In such a case, the amounts of the energy given to the film by the same heating means need not be equal in the respective steps.

As described above, in a preferred embodiment, the location of the crystal grain having a continuous crystal structure in the formed crystallized film is determined by setting the position of the specified region on the precursory film.

A second embodiment of the present invention is a crystallized film containing a first crystal grain placed at a prescribed location and a second crystal grain obtained by growth of the first crystal grain at another prescribed location.

A third embodiment of the present invention is an element employing the aforementioned crystallized film of the present invention. Preferably, in the crystallized film, the spatial location of the crystal grain having a continuous crystal structure is determined by the spatial location of the specified region in the starting film, and the crystal grain at the controlled location is employed as an active region of the element. More preferably, the active region is formed inside the single crystal grain of the crystallized film.

The fourth embodiment of the present invention is a circuit comprising the element of the present invention and a wiring connected thereto; and a unit such as semiconductor units and a displaying units constituted of the circuit, another circuit connected thereto, a sensor device, a displaying device, and the like.

The present invention enables precise control of spatial location of a crystal grain and a crystal grain boundary constituting a crystalline film by utilizing a location-controlled crystal grain as a seed crystal in growth of the crystal in a lateral direction by sequential melting-solidification.

In the present invention, a region of a film including a location-controlled crystal grain and a part of the boundary between the crystal grain and the surrounding area is defined as a melting-solidification region, and this melting-solidification region is melted by pulse-heating locally and re-solidified to grow the crystal grain in a lateral direction; thereafter the melting-solidification region is transferred in the direction of the crystal growth such that the adjacent melting-solidification regions overlaps partly with each other and the transferred melting-solidification regions include an unmelted region, and melting-solidification is conducted again. By repeating this process stepwise, at least the spatial location of at least a part of a crystal grain having a continuous crystal structure can be controlled.

In the present invention, a location-controlled crystal grain is utilized as the single crystal grain provided in a specified region of a precursory film, and this single crystal grain is grown by solid-phase crystallization of the amorphous film, or it is grown by melting-solidification of the precursory film into a crystal grain grown in the specified region. Thereby, the spatial location of the specified region can be controlled, and the spatial location of at least a part of a crystal grain having a continuous crystal structure can be controlled.

In the process for forming a film having location-controlled crystal grain by melting-solidification of the precursory film to grow the crystal grain in the specified region, the entire process can be simplified by using the same heating means commonly in the step of providing a single crystal grain in the specified region and in the step of growing the crystal grain in the lateral direction.

The crystallized film of the present invention can improve remarkably dynamic properties of an element and decrease variances of the properties thereof by correlating spatially the controlled location of the constituting crystal grain with a specified region of the element, or by forming a specified region of an element inside the location-controlled single crystal grain, in comparison with a conventional crystalline film constituted of random crystal grain.

The circuit constituted by use of the above element of the present invention can improve remarkably dynamic properties of a circuit and decrease variances of the properties thereof in comparison with a circuit employing a crystallized film constituted only of random crystal grain not controlled locationally.

The device employing an element or circuit of the present invention can be improved remarkably in the dynamic properties thereof by improvement of dynamic properties of the element and decrease of the variance thereof. Moreover, the device of the present invention has higher performance which cannot be attained by use of a conventional crystalline film produced by an SLS process.

### BRIEF DESCRIPTION OF THE DRAWINGS

FIGS. 1A, 1B, 1C, 1D, 1E, 1F, 1G, 1H and 1I are drawings for explaining a first basic embodiment of the crystallized film and the process of production thereof of the present invention.

FIGS. 2A, 2B, 2C, 2D, 2E, 2F, 2G, 2H and 2I are drawings for explaining a second basic embodiment of the crystallized film and the process of production thereof of the present invention.

FIGS. 3A, 3B, 3C, 3D, 3E and 3F are drawings for explaining an embodiment of preparation of film having location-controlled crystal grains

FIG. 4 is a drawing for explaining an embodiment of the element, circuit, and device of the present invention.

### BEST MODE FOR CARRYING OUT THE INVENTION

In the process for production of a crystallized film of the present invention, seeds for crystal grains are furnished to cause crystal growth in a lateral direction continuously with scanning by an SLS process to a film having location-controlled crystal grains prepared by any of the aforementioned embodiments. The dynamic process of the production, element, circuit, and device of the present invention are explained below in more detail by reference to examples.

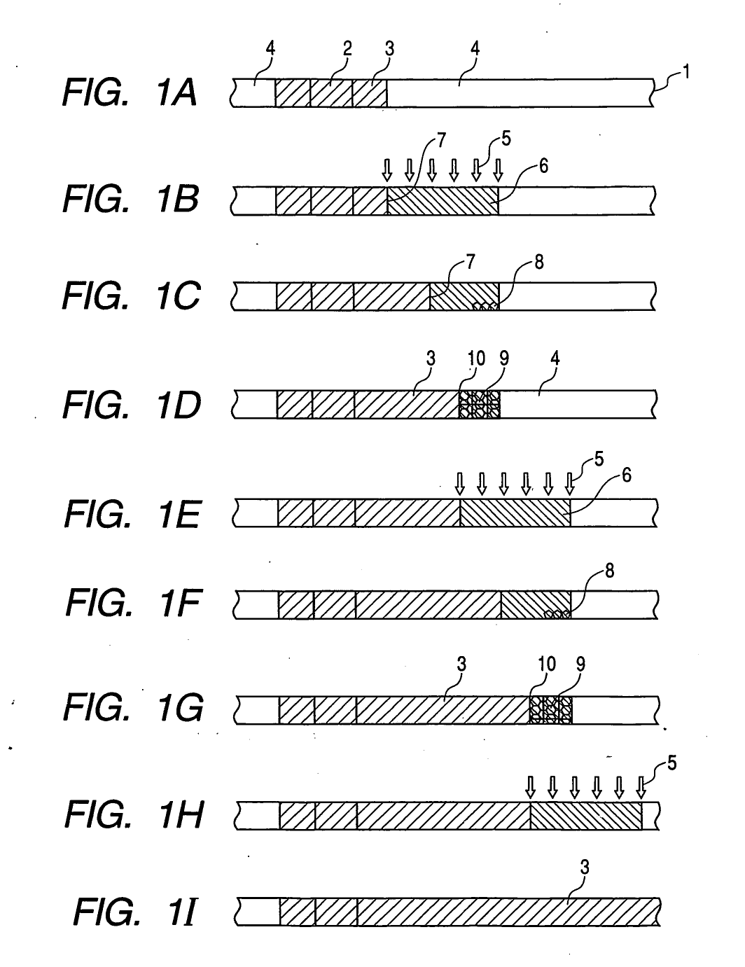

Examples of basic embodiments of the crystallized film and process of the present invention are explained by reference to FIGS. 1A through 3F. In the drawings, the film is shown schematically by sectional views of a part of the film cut along a plane vertical to the scanning direction, the sectional views showing the surfaces, interfaces, and melted regions of the film. The film of the present invention may be in contact with another layer or layers on the upper face or the lower face. However, in FIGS. 1A through 3F, the film only is shown by omitting the contacting layer. In the drawings, the numerals denote the followings: 1, a film; 2, a specified region; 3, a location-controlled crystal grain; 4, a region which does not undergo melting and re-solidification (hereinafter referred to simply as a “unmelted region”); 5, a pulse-heating means for local melting of film 1; 6, a melting-solidification region in a molten state including a part of the boundary between location-controlled crystal grain 3 and a part of the surrounding region; 7, a solid-liquid interface at the boundary between the location-controlled crystal grain 3 and the melting-solidification region in a molten state; 8, a crystal grain formed randomly by nucleation from the molten phase (hereinafter referred to as a “nucleating crystal grain”); 9, a fine crystal re-solidification region solidified by the nucleating crystal grain 8 formed by nucleation randomly from the molten phase; and 10, a crystal grain boundary between the crystal grain 3 and the fine crystal re-solidification region 9. Crystal grain 3 also denotes a crystal grain having formed by growth of the location-controlled crystal grain in a lateral direction. The region surrounding crystal grain 3 is unmelted region 4, for example, in FIG. 1A; or a region including unmelted region 4 and fine crystal re-solidification region 9 in FIG. 1D. Therefore, in the explanation below, the surrounding region is denoted by the numeral “4”, or “4 or 9”. The entire of region 6 melted by pulse-heating means 5 becomes a melting-solidification region later. Therefore, the melting-solidification region is denoted occasionally by the numeral 6.

Firstly, film 1 is prepared which has crystal grain 3 controlled locationally at specified region 2 and surrounding region 4 as shown in FIG. 1A. Then, film 1 is locally heated by pulse-heating means 5 to melt a part of surrounding region 4 including a part of the boundary between the location-controlled crystal grain 3 and surrounding region 4, thereby forming melting-solidification region 6 (FIG. 1B). After stop of local pulse-heating means 5, with progress of cooling of melted region 6, liquid-solid interface 7 between location-controlled crystal grain 3 and melted re-solidification region 6 moves from the solid side of the solid-liquid interface 7 toward the liquid side thereof (FIG. 1C). Thereby location-controlled crystal grain 3 grows in a lateral direction by re-solidification of melted region 6. On the other hand, with increase of the supercooling of melted region 6 in a molten state, spontaneous crystal nucleus formation occurs in the molten phase to form randomly nucleating crystal grains 8 rapidly in a high density (FIG. 1C) and to form fine crystal re-solidification region 9 (FIG. 1D). This fine crystal re-solidification region 9 prevents the transfer of solid-liquid interface 7 to form crystal grain boundary 10 (the boundary between the location-controlled crystal grain and crystal grains having a continuous crystal structure). With the termination of lateral growth of location-controlled crystal grain 3, the re-solidification is completed (FIG. 1D).

The steps of FIGS. 1A to 1D are the basis of the production process of the crystallized film of the present invention. Through the process, location-controlled crystal grain 3 at specified region 2 is allowed to grow laterally from the size shown in FIG. 1A to the size shown in FIG. 1D. In the case where the size of FIG. 1D is sufficient for use of the crystallized film, the melting-solidification process is finished with the one sequence of the above steps. In the case where a larger size of crystallized film is necessary, melting-solidification region 6 is transferred and the steps of FIG. 1A through FIG. 1D are repeated as shown in FIG. 1E and the following drawings. That is, the crystal grain 3 having grown in the lateral direction shown in FIG. 1D is employed as next crystal grain 3 located in the specified region, and regions including unmelted region 4, fine crystal melting-solidification region 9, and a part of crystal grain boundary 10 are employed as the next melting-solidification region 6, and this region is melted by local application of pulse-heating means 5 (FIG. 1E). As the result, by melting-solidification process (FIG. 1F) in the same manner as in the first procedure, the location-controlled crystal grain 3 extends by growing laterally (FIG. 1G). For further extension of the lateral growth distance, melt-solidification region 6 is transferred and the same steps are repeated (FIG. 1H) successively. In such procedures, a crystallized film can be produced which contains location-controlled crystal grain 3 at an intended lateral growth distance (FIG. 1I).

In the embodiment of the present invention shown in FIGS. 1A to 1I, one location-controlled crystal grain 3 is provided in specified region 2 as shown in the sectional views. Otherwise, plural specified regions may be provided in a space in which the starting film extends in the direction perpendicular to the cross section of the above embodiment, and a crystal grain may be provided in the respective specified regions. That is, when plural combinations of the specified region 2 and the crystal grain 3 are provided at constant intervals in a depth direction of cross section of FIGS. 1A to 1I, crystal grains can be allowed to extend in line with nearly equal widths in the direction of transfer of the melting-solidification regions 6, viewed from above the re-solidified crystallized films. Otherwise, plural combinations of the specified regions 2 and the crystal grains 3 may be provided in the direction of transfer of the melting-solidification region 6. In this case, the lateral growth distance of the location-controlled crystal grain 3 is limited to the vicinity to the adjacent combination of specified region 2 and crystal grain 3, and the crystal grain boundary is decided thereto.

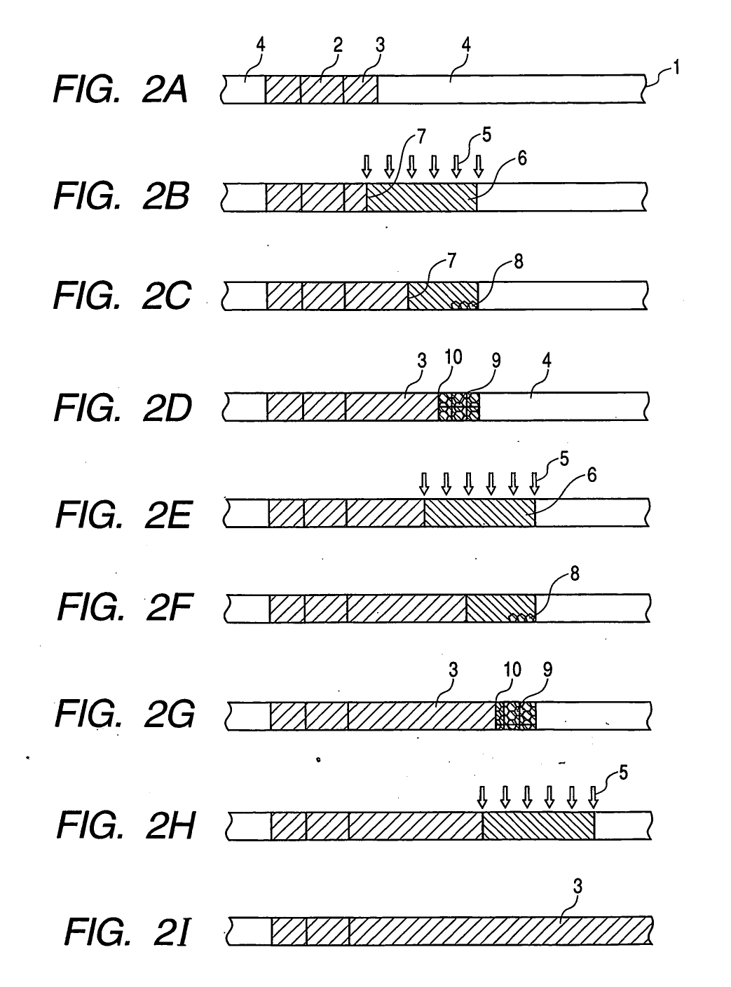

In the embodiment of the present invention shown in FIGS. 1A to 1I, one end of melting-solidification region 6 is situated at the boundary between location-controlled crystal grain 3 and the surrounding region (the boundary corresponding to crystal grain boundary 10 adjacent to random fine crystal re-solidification region 9 in the subsequent melting-solidification step). However, it is not limited thereto. It is essential only that the melting-solidification region 6 contains this boundary. For example, as shown in FIGS. 2A to 2I, melting-solidification region 6 may spread over the boundary to contain a part of location-controlled crystal grain 3, but should not contain the entire of the crystal grain 3. In repeating the melt-solidification sequentially, in this embodiment, the adjacent melt-solidification regions 6 overlap each other. In principle, the embodiment of FIGS. 1A to 1I and the embodiment of FIGS. 2A to 2I may be mixedly practiced.

Crystal grain 3 controlled locationally by specified region 2 of film 1 as shown in FIG. 1A and FIG. 2A is preferably a single crystal grain having a continuous crystal structure. This preferred embodiment ensures the retention of continuous crystal structure of the laterally growing crystal grain 3. The methods of providing specified region 2 and location-controlled crystal grain 3 on a precursor of film 1 are classified into two.

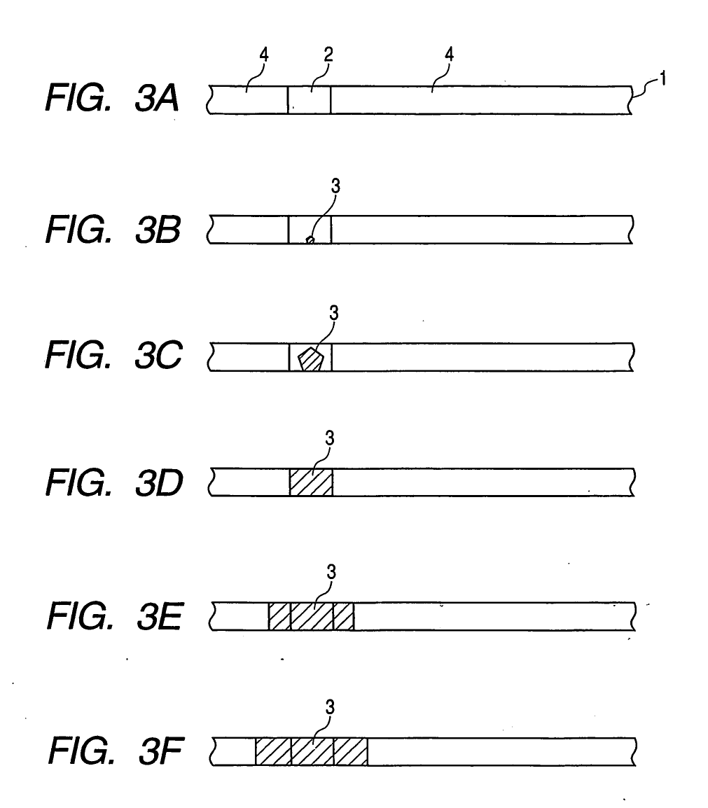

In a first method, the precursory film 1 is an amorphous film, and single crystal grain 3 is grown in a solid phase in specified region 2. Specifically in this method, as shown in FIG. 3A, specified region 2 is provided on a precursor of film 1; the entire film is annealed isothermally at a temperature below the melting point to form selectively and preferentially crystal grain 3 in specified region (FIG. 3B); the crystal grain grows in the solid phase (FIG. 3C); and after the crystal grain comes to fill entirely specified region 2 (FIG. 3D), crystal grain 3 continues to grow in the lateral direction outside specified region 2 (FIG. 3E). Thereby single crystal grain 3 can be provided at the position of specified region 2 (FIG. 3F).

For selective and preferential location control of the solid-phase crystallization, solid-phase crystallite nucleation frequency is increased by lowering the free energy barrier to crystallite nucleation in specified region 2 than in surrounding region 4 or a like method for preferential nucleation of single crystal grain 3 in the specified region 2. Otherwise, in the amorphous precursory film, the concentration of crystalline cluster is made higher or the size distribution of the crystalline cluster is made to deviate to a larger size in the specified region 2 than in the surrounding region 4 for selective and preferential growth of crystal grain 3.

In a second method, single crystal grain 3 is grown in specified region 2 by melting-solidification of a precursor of film 1. Specifically as shown in FIG. 3A, specified region 2 is provided on a precursor of film 1; the film is melted in the portion of specified region 2 to leave single crystal grain 3 unmelted selectively therein in a maximal molten state (FIG. 3B), or a nucleus of crystal grain 3 is formed preferentially from the molten phase during cooling after the melting in specified region 2 (FIG. 3B); this nucleus grows in the liquid phase (FIG. 3C) throughout specified region 2 (FIG. 3D) and grows further laterally outside specified region 2 (FIG. 3E) to form single crystal grain 3 at the position of specified region 2 (FIG. 3F).

The location control of the selective and preferential crystallization by melting and re-solidification can be conducted as mentioned above in the first method.

In any of the above two methods for providing a single crystal grain in a specified region, the solid-phase crystallization or melting and re-solidification may be conducted after putting crystal grain 3 preliminarily on a substrate and forming thereon the precursor of film 1. To put crystal grain 3 on an intended position of specified region 2, various methods can be employed such as selective deposition.

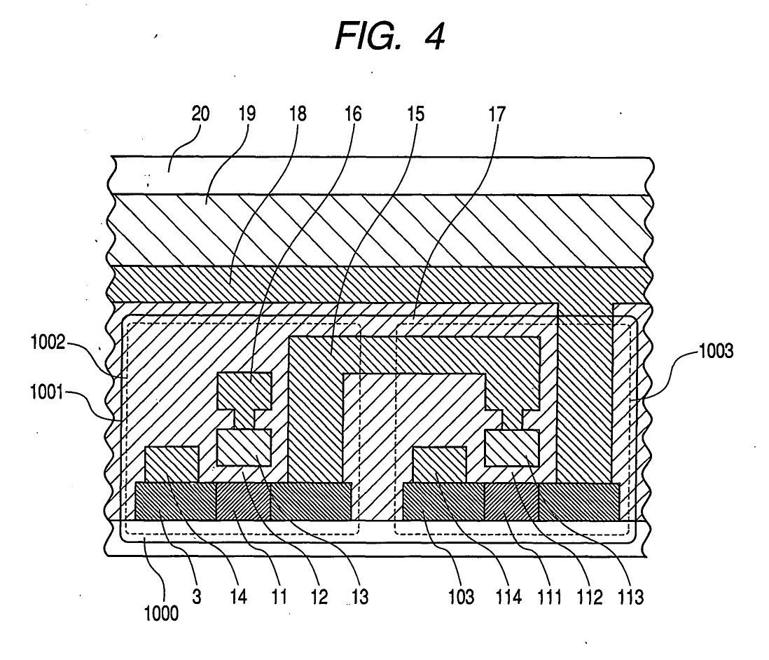

A typical example of the embodiment of the element, circuit, and device of the present invention employing the crystallized film formed by the above-mentioned melting-solidification process is explained by reference to FIG. 4. FIG. 4 is a sectional view of a part of an image display device which has a switching circuit mainly constituted of a MOS type film transistor provided in a crystallized film composed of a semiconductor material. In the drawing, the numerals denotes the following: 1001, an area of the switching circuit; 1002 and 1003 respectively, a first TFT and second TFT constituting the switching circuit 1001; 1000, a substrate; 3 and 103, location-controlled crystal grain having grown laterally from the specified region, and corresponding to the reference numeral 3 in FIGS. 1A to 1I and FIGS. 2A to 2I; 11 and 111, a gate region formed in crystal grain 3 and crystal grain 103; 12 and 112, a gate insulation film; 13 and 113, a gate electrode; 14 and 114, a source electrode; 15, an electrode wiring serving as a drain electrode of the first TFT 1002, a gate wiring electrode of the second TFT 1003, and an electrode wiring of the above two electrodes (hereinafter referred to as a “multipurpose gate wiring electrode”); 16, a gate wiring electrode of the first TFT 1002; 17, an interlayer insulation layer; 18, a pixel electrode; 19, a luminescent layer or a transmittance-variable layer; and 20, an upper electrode. Crystal grains 3 and 103 can be formed by growing crystal grain 3 laterally from specified region 2 through steps shown in FIGS. 1A to 1I or FIGS. 2A to 2I and by patterning a part of the crystal grain.

In the crystallized film of the present invention, the location and size of crystal grain 3 are decided by the location of the specified region 2 and the direction and distance of transfer of a part of the melted region. Therefore, in formation of the element having the active region in crystal grain 3, the active region of the element can be correlated readily with the location of crystal grain 3. That is, as shown in FIG. 4, gate region 11 which is an active region of TFT 1002, an element of this device can be limited inside crystal grain 3. In this example, no crystal grain boundary is included in the active region of TFT 1002. Thereby the element characteristics are improved and variations among the elements are decreased.

In the switching circuit shown in FIG. 4, the drain electrode (multipurpose gate wiring electrode 15) of first TFT 1002 controlled by gate electrode 13 is connected through a wiring to gate electrode 113 of second TFT 1003. The electrodes and wirings are insulated from each other by interlayer insulation layer 17. Therefore second TFT 1003 controlled by gate electrode 113 is controlled by the drain voltage of first TFT 1001. In such a circuit, element characteristics of the first and second TFTs should be precisely controlled. The circuit of the present invention satisfies the above conditions since no grain boundary is included in the active region.

In the image display device shown in FIG. 4, the voltage applied or the current injected by pixel electrode 18 and upper electrode 20 to luminescent layer or transmittance-variable layer 19 is controlled by the drain voltage or current of second TFT 1003 which is controlled by the drain voltage of first TFT 1002. The luminescence intensity of the luminescent layer or the light transmittance of the transmittance-variable layer 19 is controlled by the voltage applied or current injected thereto. The image displaying apparatus of this example is constituted of plural elements as the pixel display unit arranged in lattice. For obtaining uniform light intensity and time response as an image displaying apparatus, variation of properties of the pixels should be decreased. The circuit of the present invention satisfies the above conditions since no grain boundary is included in the active region.

### EXAMPLE 1

A crystalline silicon film formed through the steps of FIGS. 1A to 1I and FIGS. 3A to 3F is described as a first example of the present invention.

A hydrogenated amorphous silicon film containing no crystalline silicon cluster was deposited as a precursory film in a thickness of 100 nm on a glass base plate as the substrate having amorphous silicon oxide surface by plasma chemical vapor deposition. The deposited film was dehydrogenated by heat treatment. On the surface of this amorphous silicon film, amorphous silicon oxide film was deposited in a thickness of 150 nm by sputtering. This amorphous silicon oxide film was patterned by photolithography to leave amorphous silicon oxide islands of 1 μm square on 10 μm×50 μm rectangular lattice points. By utilizing this amorphous silicon oxide islands as the mask, silicon ions were implanted from the surface at an acceleration energy of 70 keV and a dose of 2×10¹⁵ cm⁻². Then the amorphous silicon oxide island mask was removed. The film was annealed isothermally in a nitrogen atmosphere at 600° C. for 15 hours. As the result, single crystal grains of a size of about 3 μm were found to have grown at the 10 μm×50 μm rectangular lattice points where the amorphous silicon oxide islands of 1 μm square as the mask had once been formed and the surrounding area was found to be still amorphous.

Next, an XeCl excimer laser beam shaped into a line beam of a width of 4 μm was projected in a pulse onto the film at an energy density of 400 mJ·cm⁻². On laser beam irradiation, the spot length direction was made to be parallel to the short axis direction of the masked regions of 1 μm square arranged at 10 μm intervals of the rectangular lattice, and the center of the 4 μm-wide laser beam was placed at 3 μm apart from the center of the crystal grain. The same laser beam was irradiated by moving in parallel by 2 μm step in the width direction.

The resulting crystallized film was found to be filled up with crystal grains of an average size of 10 μm in width and 50 μm in length arranged in a rectangular lattice throughout the entire of the film. By detailed observation, the crystal grains were found to be in a chevron shape having convexes and concaves at both ends in the 50 μm length direction. At the convexes of the chevrons, seemingly, traces of the 1 μm square amorphous silicon islands were observed which were employed as the mask for the ion injection. The chevron-shaped crystal grains constituting the crystallized film of this Example is considered to have grown laterally from the single crystal grains of the sizes of about 3 μm at the rectangular 10 μm×50 μm lattice points as crystal seeds by transfer and repetition of laser beam irradiation. Therefore, the regions directly under the 1 μm square amorphous silicon oxide islands at the 10 μm×50 μm rectangular lattice points on the starting film, the single crystals of about 3 μm in size controlled locationally at the positions, and the surrounding regions respectively correspond to “specified region 2”, “crystal grain 3”, and “surrounding region 4” in FIGS. 1A to 1I.

In this Example, single crystals were formed by selective preferential solid-phase crystallization respectively in specified regions in a film on an amorphous substrate; the regions, as melting-solidification regions, covering a part of the boundary between the crystal grain and the surrounding region and a part of the surrounding region having an unmelted area were pulse-heated locally to cause melting and re-solidification to grow the crystal grains laterally. This step of melting and re-solidification was repeated sequentially with transfer of the melting-solidification region with partial overlapping of the succeeding melting-solidification regions for each repeated melting-solidification step to grow successively the location-controlled crystal grains laterally. Thereby, in this example, a crystallized film was prepared which comprises crystal grains controlled in spatial location.

### EXAMPLE 2

In this Example 2 of the present invention, a crystalline silicon film was formed through the steps shown in FIGS. 2A to 2I and FIGS. 3A to 3F.

A film was prepared in the same manner as in Example 1 except the steps after silicon ion implantation and removal of the masking amorphous silicon oxide islands. Differently from Example 1, the isothermal annealing in a nitrogen atmosphere at 600° C. for 15 hours for solid phase crystallization was not conducted, but instead the whole area of the film was irradiated with a KrF excimer laser without shaping the laser into a line beam at an energy density of 400 mJ·cm⁻². Thereby, a crystallized film was formed in which single crystal grains in a size of about 2 μm were formed in an arrangement of 10 μm×50 μm rectangular lattice points where the 1 μm square amorphous silicon oxide mask islands had once been formed, and the areas surrounding the single crystal grains were filled with random fine crystal grains of about 50 nm in average grain size.

The crystallized film was irradiated by the same excimer laser beam as in Example 1 at an energy density of 450 mJ·cm⁻² successively. In the first irradiation of the laser beams, similarly in Example 1, the laser spot length direction was made parallel to the short axis direction of the masked regions of 1 μm square arranged at 10 μm intervals of the rectangular lattice, and the center of the 4 μm-wide laser beam was placed at 2 μm apart from the center of the crystal grain, and in the second and later irradiation the laser beam was irradiated repeatedly with transfer in parallel stepwise by 2 μm.

The resulting crystallized film was found to be filled up with crystal grains of an average size of 10 μm in width and 50 μm in length arranged in a rectangular lattice throughout the entire of the film similarly as in Example 1. The crystal grains constituting the crystallized film of this Example is considered to have grown laterally from the single crystal grains of the sizes of about 2 μm at the rectangular 10 μm×50 μm lattice points as crystal seeds by repetition of laser beam irradiation and transfer thereof. By observation of the crystallized film taken out during the repeated irradiation of the laser beams, one lateral growth distance was found to be 3 μm. This means that, in each laser beam irradiation, a region of 1 μm wide of the melt-solidification region of 4 μm wide included a part of the crystal grain having grown in the preceding lateral growth. Therefore, the regions directly under the 1 μm square amorphous silicon oxide islands at the 10 μm×50 μm rectangular lattice points on the starting film, the single crystals of about 2 μm in size controlled locationally at the positions, and the surrounding regions correspond respectively to “specified region 2”, “crystal grain 3”, and “surrounding region (9)” in FIGS. 2A to 2I.

This Example is different from Example 1 in that, in production of the film having location-controlled single crystal grains by selective preferential melting and re-solidification, the melting-solidification region included not only a part of the boundary between the location-controlled crystal grain and the surrounding region, but included also a part of the crystal grain.

### EXAMPLE 3

In this Example 3 of the present invention, a crystalline silicon film was formed through the steps shown in FIGS. 2A to 2I and FIGS. 3A to 3F, but is different from Example 2.

A film was prepared in the same manner as in Example 2 except the steps after silicon ion implantation and removal of the masking amorphous silicon oxide islands. Differently from Example 2, without conducting the step of irradiation with non-shaped laser light, the step of repeated irradiation with the laser line beam was conducted as below.

The obtained amorphous film was irradiated repeatedly with the same KrF excimer laser light shaped in a line beam spot similarly as in Example 2. In the irradiation of the laser beams, similarly in Example 2, the laser spot length direction was made parallel to the short axis direction of the amorphous silicon oxide island mask regions of 1 μm square arranged at 10 μm intervals of the rectangular lattice. In the first irradiation, the center of the 4 μm-wide laser beam was directed to the center of the region, and the beam was projected at an energy density of 400 mJ·cm⁻². In the second and later irradiations, the energy density was increased to 500 mJ·cm⁻², and the laser beam was projected repeatedly with transfer in parallel stepwise by 2 μm.

The resulting crystallized film was found to be filled up with crystal grains of an average size of 10 μm in width and 50 μm in length arranged in a rectangular lattice throughout the film similarly as in Example 2. By observation of the film immediately after the first irradiation of the laser beam, the single crystal grains of a size of about 2 μm were arranged within the laser irradiated column the rectangular lattice points of 10 μm×50 μm where the masking amorphous silicon oxide islands of 1 μm square had once been provided; the surrounding regions of about 4 μm wide having been irradiated with the laser beam were filled up with random fine crystal grains of an average diameter of about 50 nm; and the outer regions were remaining in an amorphous state. The crystal grains constituting the crystallized film of this Example are considered to have grown from the single crystal grains, as the seeds, of about 2 μm in size formed by first laser beam irradiation at 10 μm×50 μm rectangular lattice points and grown laterally further by succeeding repeated laser beam irradiation with irradiation site transfer. Therefore, the regions directly under the 1 μm square amorphous silicon oxide islands at the 10 μm×50 μm rectangular lattice points on the starting film, the single crystals of about 2 μm in size formed at the first laser beam irradiation with location control at the positions, and the surrounding regions respectively correspond to “specified region 2”, “crystal grain 3”, and “surrounding region 4,9” in FIGS. 2A to 2I.

This Example is different from Example 2 in that the same heating means was employed in both of the step of growing simple crystal grains by melting and re-solidification in specified regions and the step of growing laterally the simple crystal grains.

### EXAMPLE 4

This Example 4 shows a MOS type TFT element having a structure shown in FIG. 4, a TFT integrated circuit, and an EL image displaying device.

A matrix of single silicon crystal grains of 10 μm in average width and 50 μm in average length was provided on a glass substrate having a silicon nitride film and an silicon oxide film laminated on the surface thereof by any of the processes described in Examples 1-3. Then a gate insulation film and a gate electrode film were deposited through a conventional low-temperature process for silicon film transistor. The gate electrode film was removed from the areas except the middle portions of 1 μm wide of single crystal grains. By a self alignment technique by utilizing the unremoved gate electrode film portions as the mask, boron was doped into the non-masked areas to form gate regions, source regions, and drain regions. Thereby, the respective gate regions were formed entirely inside the single crystal grains. Then a passivation layer constituted of an insulation film was deposited, and apertures were formed in the passivation layer corresponding to the respective regions. Finally, aluminum wiring layer was deposited and patterned to form gate electrodes, source electrodes, and drain electrodes to obtain a MOS type TFT.

The results of tests of the obtained MOS type TFT for operating characteristics showed that the TFT is capable of operating at a higher speed, by twice or more in average mobility, than the element formed on a random polycrystalline film without providing the “specified region 1” of the present invention by the same process in the same shape. The variation of the element characteristics was reduced: by half as to the mobility, and to about ¼ as to the threshold voltage.

The adjacent two elements of the MOS type TFTs were connected as below. The drain electrode of the first TFT was connected to the gate electrode of the second TFT. The gate electrode of the second TFT was connected through a condenser element to the source electrode of the same TFT. Thereby an integrated circuit constituted of two TFT elements and a condenser element. In this circuit, the source current supplied to the source electrode of the second TFT is controlled by the condenser capacity of the condenser element, whereas the condenser capacity and the condenser switching are controlled by the gate voltage of the first TFT. This circuit is useful, for example, as an element circuit for switching and current control of pixels in an active matrix display device.

Basic operating characteristics of the circuit prepared in this Example were measured, and were compared with the characteristics of the circuit prepared by the same process and in the same shape as above on a random polycrystalline film not provided with the “specified region” of the present invention. It was confirmed that the operation can be conducted at a higher rate by a factor of 3 or more in operating switching frequency, and the control range of the current outputted from the drain electrode of the second TFT is broadened by a factor of about 2.

The variations of characteristics of the same kind of circuits were decreased to a half level or lower. This means that the variations of the characteristics among the first TFTs and among the second TFTs in the respective circuit are small, and further the characteristics of the first TFT and the second TFT in the same circuit are uniform in comparison with those of the comparison object.

Next, the above TFT integrated circuits were arranged on a square lattice points at intervals of 100 μm on a glass substrate, and were employed as element circuits. The unit cells of the square lattice were connected by wiring as below for using as pixels of an image displaying device. Firstly a scanning line in one axis of the square lattice was provided for each of the lattices, and the gate electrode of the first TFT of each of the element circuits was connected to it. On the other hand, in the direction perpendicular to the scanning line, a signal line and a source line were wired for each of the lattices, and connected to the source electrode of the first TFT and of the source electrode of the second TFT in the respective element circuits. On the integrated element circuit, an insulation layer was laminated. Openings were formed to bare the drain electrodes of the second TFT of the element circuit. Then a metal electrode was laminated, and this metal electrode was separated for insulation for the respective pixels. Finally thereon an electroluminescence (EL) layer and an upper transparent electrode layer were laminated. Thus, an active matrix type of multiple gradation EL image display device was constructed which conducts switching and injection current control of pixels by the TFT integrated circuit.

In the image display device of this Example, an electric charge is stored from the source line into the condenser element corresponding to the electric current given to the signal line by activation of the first TFT by voltage of the scanning line. A current controlled by the gate voltage of the second TFT is introduced from the source line to the EL light-emitting layer corresponding to the stored electric charge.

The basic operating characteristics of the image display device formed in this Example were measured, and compared with the characteristics of an image forming device formed on a polycrystalline film through the same steps in the same shape by a conventional SLS process without employing the present invention. As the results, it was confirmed that the maximum luminance and maximum contrast as the static properties were improved by a factor of about 1.5, the gradation reproducing range was expanded by a factor of about 1.3, and the defective pixel ratio and the brightness variance were reduced respectively to ½. The maximum frame rate as the dynamic characteristic was improved by a factor of about 2. The improvement of these dynamic operating characteristics is due entirely to the above improvement and reduction of variation of the element circuit characteristics, and due to the improvement and variation reduction of the film transistor characteristics constituting element circuit. These are result from the formation of the active regions of the transistor in single crystal grain.

1. A process for producing a crystallized film, comprising the steps of: preparing a film having a crystal grain at a prescribed location; melting a part of a region surrounding the crystal grain of the film and a part of a boundary between the crystal grain and the surrounding film locally by pulse heating; and re-solidifying the melted region.

2. The process for producing a crystallized film according to claim 1, wherein the film is in contact with a surface of a substrate, and the crystal structure of the surface of the substrate in contact with the region of melting and re-solidification of the film and the crystal structure of the formed crystallized film are not continuous.

3. The process for producing a crystallized film according to claim 1, wherein the step of re-solidification allows a crystal to grow from the crystal grain at the prescribed location in a lateral direction.

4. The process for producing a crystallized film according to claim 1, wherein the surrounding region outside the location-controlled crystal grain is completely melted.

5. The process for producing a crystallized film according to claim 1, wherein the process comprises, after the step of the re-solidification, further a step of melting locally by pulse-heating a portion of the region surrounding the crystal grain having grown in the re-solidification step together with a portion of the boundary between the crystal grain having grown in the step and surrounding film; and a step of re-solidifying the melted region.

6. The process for producing a crystallized film according to claim 5, wherein the repeated step of the melting and re-solidification is conducted plural times.

7. The process for producing a crystallized film according to claim 5, wherein the region of the melting and re-solidification in the repeated step of the melting and re-solidification is overlapped partly with the region of the melting and re-solidification of the preceding step of the melting and re-solidification.

8. The process for producing a crystallized film according to claim 7, wherein the melting-solidification region in the repeated melting-solidification step includes the grain boundary of crystal grain having a crystal structure continuous to the location-controlled crystal grain.

9. The process for producing a crystallized film according to claim 5, wherein the melting-solidification region in the repeated melting-solidification steps covers a region having not been employed yet as the melting-solidification region.

10. The process for producing a crystallized film according to claim 1, wherein the step of providing a film having a crystal grain placed at a prescribed location comprise a step of providing a single crystal grain in a specified region of a precursor of the film.

11. The process for producing a crystallized film according to claim 10, wherein the precursor of the film is an amorphous film, and the step of providing a single crystal grain at a prescribed location is a step of growing a crystal grain by solid-phase crystallization of the amorphous film.

12. The process for producing a crystallized film according to claim 10, wherein the step of providing a single crystal grain at a prescribed location is a step of growing a crystal grain by melting-resolidification of the precursor of the film.

13. The process for producing a crystallized film according to claim 12, wherein the step of growing the crystal grain by melting-resolidification of the precursor of the film and melting and resolidifying steps in a process for producing a crystallized film comprising the steps of preparing a film having a crystal grain at a prescribed location, melting a part of a region surrounding the crystal grain of the film and a part of a boundary between the crystal grain and the surrounding film locally by pulse heating and re-solidifying the melted region, are conducted continuously by means of one and the same heating means.

14. The process for producing a crystallized film according to claim 10, wherein a spatial location of the crystal grain having a continuous crystal structure in the crystallized film is decided by fixing a spatial location of the specified region.

15. A crystallized film, comprising a crystal grain placed at a prescribed location, and another crystal grain grown laterally from the grain at a prescribed location.

16. An element, comprising a crystallized film set forth in claim 15, and arranging an elementary element in correspondence with the location of the crystal grain.

17. The element according to claim 16, wherein the crystal grains are utilized respectively as an active region of an active element.

18. The element according to claim 17, wherein the active region of the element is formed inside the single crystal grain of the crystallized film.

19. A circuit, comprising an element set forth in claim 16, and wiring connected to the element.

20. A device, comprising a circuit set forth in claim 19 and a semiconductor device or a display device connected to the circuit.
